(19) United States
(12) Patent Application Publication
(10) Pub. No.: US 2012/0251229 A1
(43) Pub. Date: Oct. 4, 2012

(54) LATCHING MECHANISM FOR BATTERY PACK OF ELECTRICAL TOOL

(75) Inventors: Chia-Sheng Liang, Taipei Hsien (TW); Chu-Hsiang Tseng, Taipei Hsien (TW)

(73) Assignee: DE POAN PNEUMATIC CORP.

(21) Appl. No.: 13/078,034

(22) Filed: Apr. 1, 2011

(51) Int. Cl. H01M 2/10; F16B 1/00

(52) U.S. Cl. 403/325; 403/321

(57) ABSTRACT

A latching mechanism for a battery pack of an electrical tool includes a button slidingly positioned in the battery pack, and the battery pack can be received in a groove formed on an end of the handle of the electrical tool. The button has a latching element positioned on each side of the path, and a pushing element is positioned between the button and the latching element; the pushing element can move back and forth along the button to further drive the latching element to move back and forth, and enable the latching element to buckle to the inner sidewall of the groove outside the two sides of the base and release from the inner sidewall of the groove thereby, as well to position and release the battery pack in the groove.

### BACKGROUND

1. Technical Field

The present invention relates to a latching element for a battery pack of an electrical tool. More particularly, the present invention relates to engage a battery pack into a groove formed in a distal end of a handle of the electrical tool, and more particularly, to a latching element positioned in the groove of the battery pack, as well as to a button and a pushing element connected to the latching element.

2. Related Art

The latching mechanism of a battery pack in a conventional electrical tool, referring to U.S. Pat. No. 5,213,913 and U.S. Pat. No. 6,326,101, includes a groove formed on an end portion of the handle of the electrical tool and a resilient button respectively formed on two sides of the battery pack, and a latching element is positioned on a top of the button to allow the top of the battery pack to be received into the groove. The latching element is driven by a resilient member to hold on to the inner sidewall of the groove to position the battery pack to supply power to the electrical tool via the handle. By pressing the button, the latching element can be released from the inner sidewall to release the battery pack. However, the loss of elasticity of the resilient member motivating the button and the latching element often occurs after a long time use, which may cause the latching element to come loose from the groove; and as the button and the latching element do not have any specific axle or track, and therefore, operation thereof can be a problem.

Recently, U.S. Pat. No. 5,792,573 and US patent application No. 2008207026 disclose a latching mechanism for a battery pack of a electrical tool, which mainly comprises two corresponding open tracks formed on the inner sidewall of the groove and protruded strips positioned respectively on both sides of the battery pack for fitting into the tracks so that the battery pack can slide along the tracks in the groove. A resilient button is positioned on an end portion of the handle and a latching element is positioned on the button, the latching element is driven by a resilient member to hold a top of the battery pack for positioning the battery pack. By pressing the button, the latching element can be released to release the battery pack. However, the loss of elasticity of the resilient member motivating the button and the latching element often occurs after a long time use, which may cause the latching element to come loose from the groove.

U.S. Pat. No. 7,671,562 discloses another structure of a latching mechanism for the battery pack of the electrical tool, which is different from the two above mentioned U.S. Pat. No. 5,792,573 and US patent No. 2008207026. The battery pack has a latching element formed on a top thereof and a button formed on a side thereof. The latching element can be driven by the button used for holding an end of the handle to position the battery pack. By pressing the button, the end of the handle is released from the latching element to release the battery pack. However, the connection between the button and the latching element is not clearly and sufficiently disclosed in this patent.

### BRIEF SUMMARY

The present invention provides a structure of a latching mechanism for the battery pack of an electrical tool. The battery pack can be positioned by restricting two corresponding positions of a resilient member, and thereby increase the lifespan of the resilient member and prevent the battery pack from coming loose. The structure of the latching mechanism is different compared to the above mentioned U.S. Pat. Nos. 5,213,913, 6,326,101, 5,792,573, 7,671,562 and US patent application No. 2008/0207026.

The latching mechanism for a battery pack of an electrical tool comprises a base formed in the battery pack and is received in a groove formed on a distal end of a handle of the electrical tool. The latching mechanism comprises: a button, slidingly positioned in the base in an elastic load fashion, wherein an inner portion and an outer portion are respectively formed on two sides of the button, and the button will move back and forth along a path within the base by a pressing force applied on the outer portion of the button; two latching elements, respectively slidingly positioned in the base along a moving path, and proximate to an inner portion, an inner sidewall of the base restricting the latching elements to move along the moving path in a vertical direction, thereby enabling the latching elements to move and protrude out of two sides of the base; and two elastic pushing elements, respectively positioned between the inner portion and the latching elements; the elastic pushing elements move back and forth along with the button, wherein by moving the latching elements back and forth, the latching elements can respectively buckle to two inner sidewalls of the groove or release therefrom.

Accordingly, the button and the latching element respectively carry the elasticity of a resilient element and the elastic force along a single direction, and thus make the button particularly drive the elastic pushing elements to move back and forth along the path. Accordingly, the elastic pushing element particularly drives the latching element to move back and forth along a vertical direction. The two latching elements are used to be restricted on the two sides of the base symmetrically in order to position the battery pack. Accordingly, in the principle of providing different technology compared to the prior arts, the present invention comprises two elastic elements positioned therein to increase the lifespan thereof, as well as increase the smoothness while pressing the button to release the battery pack from the latching element, and the stability of the latching element for the battery pack can be increased.

The present invention also comprises: two corresponding open tracks formed on two sides of the groove; a protruded strip is formed on each side of the base for being inlayed into the track, and thereby allows the base to slide within the groove along the tracks; and two sides of the inner sidewall of the groove have two corresponding open buckling grooves; the latching elements exposed out of the two sides of the base and inlayed into the buckling groove are buckled to the inner sidewalls of the groove.

The base comprises an opening on a bottom portion exposed out of the groove, and a path is formed between a top and a bottom of base to allow the button slide up and down within the base. The inner portion is positioned on a top of the button and the outer portion is positioned on a bottom of the button and exposed out of the base through the opening.

A spring is positioned between the button and the inner sidewall of the base, and the button has elasticity provided by the spring. The button has a positioning groove formed on a top thereof, and the spring is positioned between the positioning groove and the inner sidewall of the base to drive the button to move downwards.

Along the path on the two sides of the inner sidewall of the base, a sliding track is vertically formed, and a through opening is formed on the two sides of the base connecting to the sliding track; and the latching element is positioned to slide within the sliding track and restricted by the inner sidewall of the base.

The latching element has a guiding groove formed vertically along the path. A track is formed vertically along the path respectively on the two sides of the inner sidewall of the base. The latching element is positioned on the track through the guiding groove, and thereby enable to slide along the path back and forth vertically.

A diagonal through hole is formed on the latching element to provide the latching element movably concealing onto the pushing element.

The latching element has a buckling portion extending along the path vertically, and the buckling portion can move to the outer part of the base along with the latching element. The buckling portion has a slope facing upwards and a back facing the button.

The pushing element is positioned in the inner portion and extends along the path respectively and declining towards two sides of the base. The pushing elements are positioned in a V shape.

The pushing element comprises more than one bent portion capable of accumulating elasticity in order to increase the elasticity of the pushing element.

The pushing element is formed as a one-piece element and positioned on two distal ends of a resilient element, which is bent in a V shape. The button has a space inlayed with the resilient element.

The electrical tool can be an electrical screw gun, an electrical staple gun, an electrical screw driver, an electrical driller or an electrical impact wrench.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view according to a preferred embodiment of the present invention;

FIG. 2 is a partial sectional side view of FIG. 1;

FIG. 3 is an exploded view of the battery pack shown in FIG. 1;

FIG. 4 is an assembly view of a button, pushing element and latching element shown in FIG. 3;

FIG. 5 is a front view of the partial sectional side view of FIG. 1;

FIG. 6 is a partial enlarged view of the latching element of FIG. 5;

FIG. 7 is a sectional view taken along the A-A portion of FIG. 5;

FIG. 8 is a sectional view taken along the B-B portion of FIG. 5;

FIG. 9 is a partial enlarged view of the button, the pushing element and the latching element of FIG. 7;

FIG. 10 is an operational aspect of FIG. 9;

FIG. 11 is an operational aspect of FIG. 7; and

FIG. 12 is another operational aspect of FIG. 9.

### DETAILED DESCRIPTION

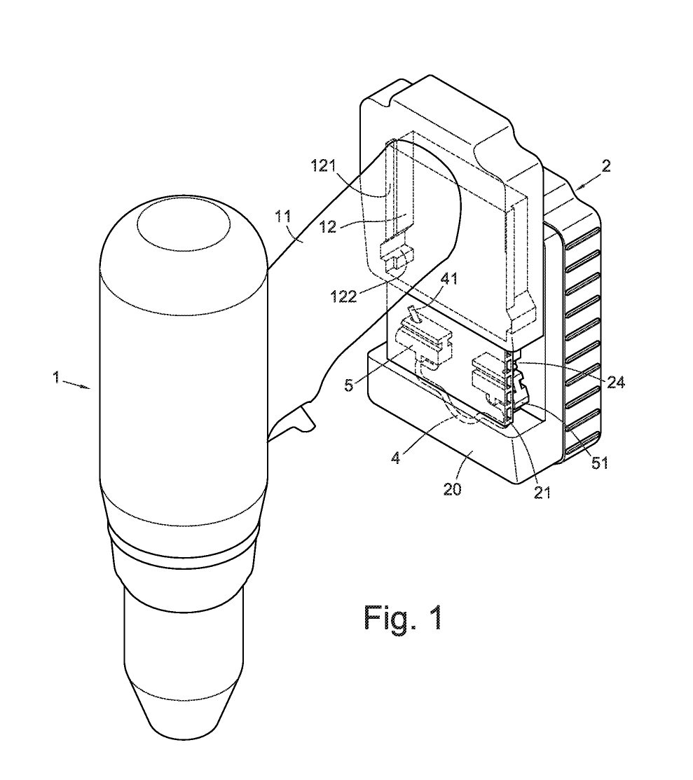

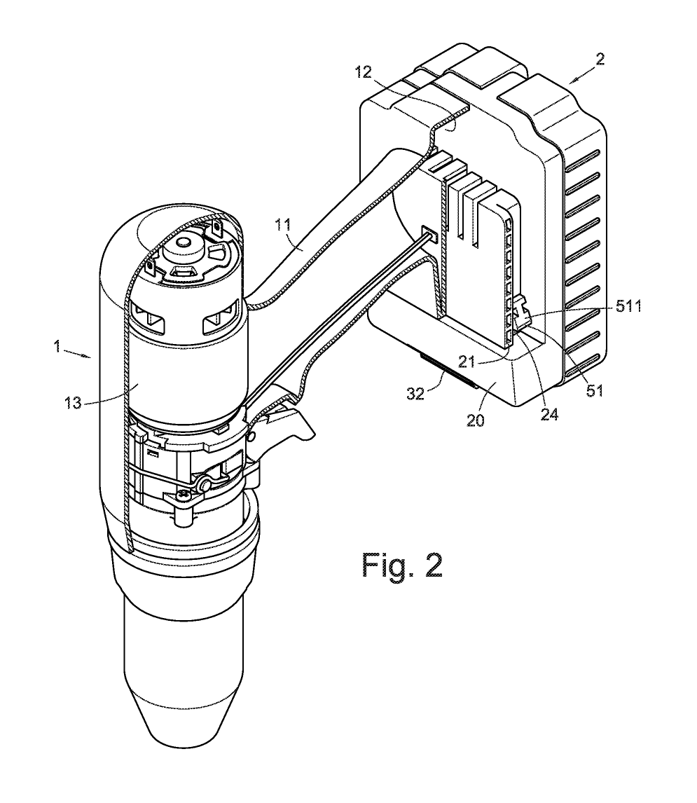

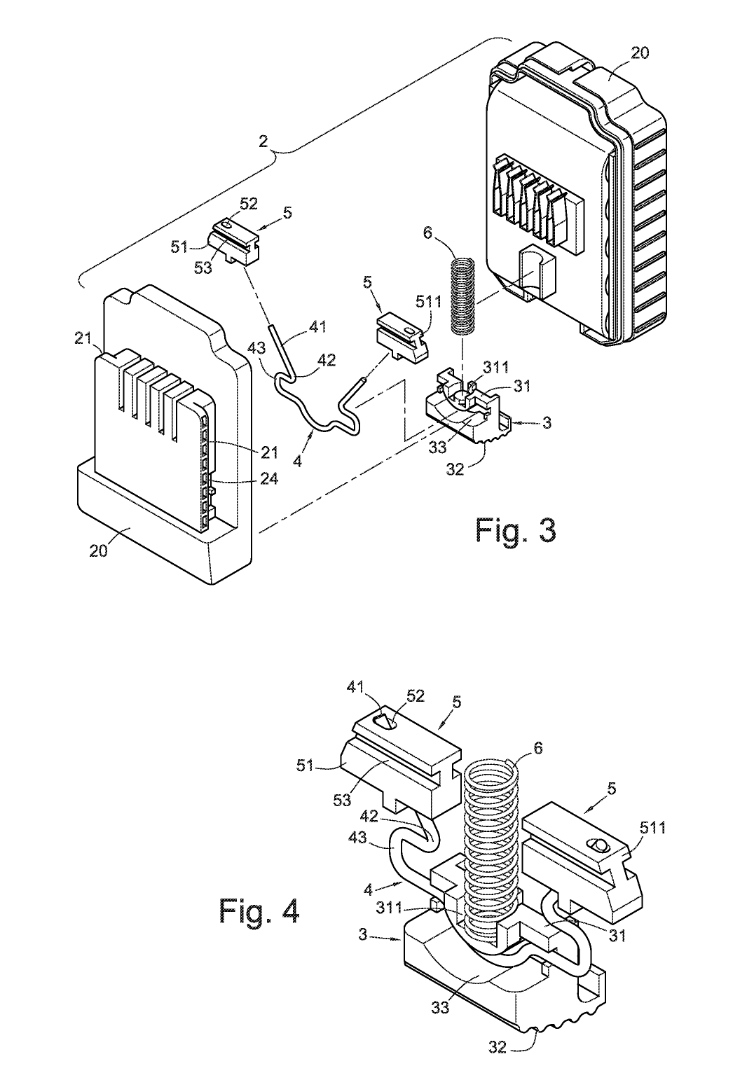

FIG. 1 is a perspective view according to a preferred embodiment of the present invention, demonstrating the latching mechanism for a battery pack of an electrical tool in the present invention referring concurrently to FIGS. 2, 5 and 7. The latching mechanism is positioned in a battery pack 2 (referring to FIG. 3). The battery pack 2 comprises a base 20 that can be received in a groove 12 formed on a distal end of a handle 11 of an electrical tool 1. The electrical tool 1 in the present embodiment of the present invention can be a screw gun. The groove 12 comprises two corresponding open buckling tracks 121 formed on two inner sidewalls (referring to FIG. 8) thereof. A protruded strip 21 is respectively positioned on two sides of the joining face of the base 20 and the groove 12 and received into the buckling track 121 so that the base 20 slides up and down within the groove 12. The base 20 has a chamber 22 formed there-within, and an opening 23 is formed on a bottom of the base 20 to join the chamber 22 with an external space. When the base 20 is received into the groove 12, the opening 23 can be exposed out of the groove 12. The power of the battery pack 2 can be supplied to the electrical tool 1 through the handle 11 to motivate the rotation of a motor 13.

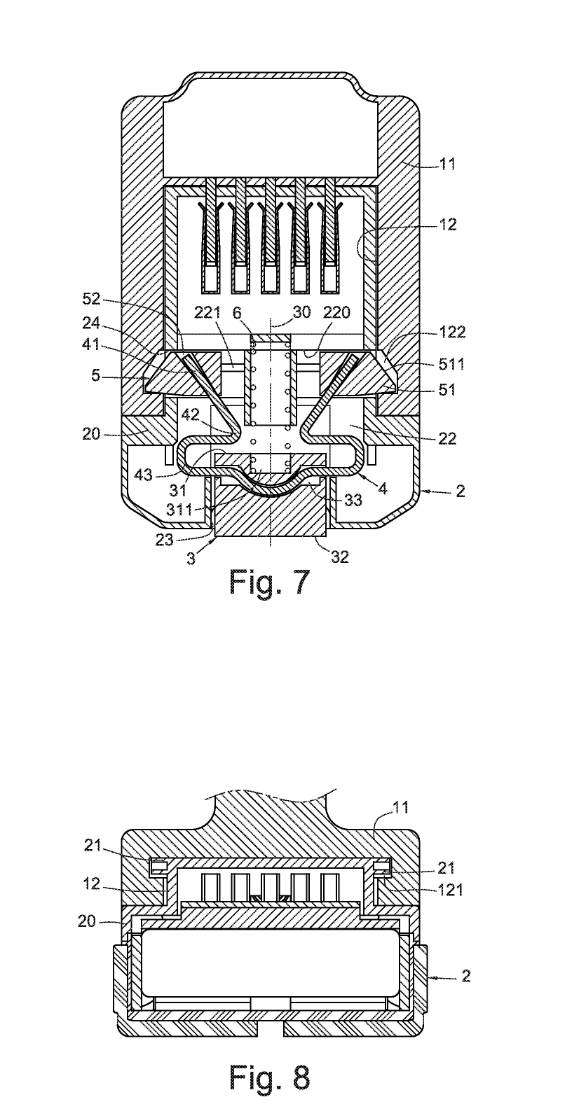

According to the above depiction, the latching mechanism comprises a button 3, two latching elements 5 and two elastic pushing elements 41. The button 3 has elasticity to position and slide in the chamber 22 of the base 20 (referring to FIGS. 3 and 4). An inner portion 31 and an outer portion 32, for an operator to touch, are respectively formed on two sides of the button 3. The outer portion 32 of the button 3 can be touched by an operator's hand to move the button 3 back and forth along the path 30 in the base 20 (as shown in FIG. 7). In an embodiment, the inner portion 31 can be positioned on a top of the button 3, and the outer portion 32 can be positioned on a bottom of the button 3 that protrude out of the base 20 through the opening 23. The path 30 is formed between the top and the bottom of the base 20 to allow the button 3 to slide up and down within the chamber 22. A coiled spring 6 is positioned between the inner portion 31 of the button 3 and the chamber 22 of the base 20. The spring 6 provides the elasticity to the button 3. A positioning groove 311 is formed in the inner portion 31 of the button 3, and the spring 6 is positioned between the positioning groove 311 and the chamber 22 of the base 20, thus the spring 6 can drive the button to move downwardly.

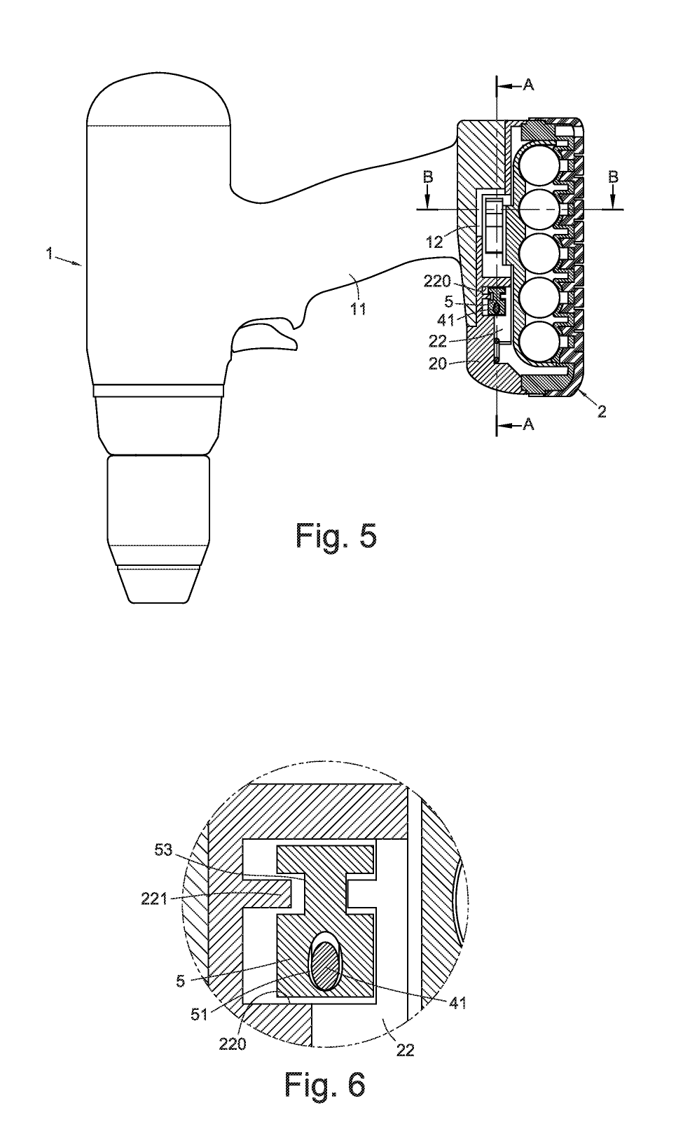

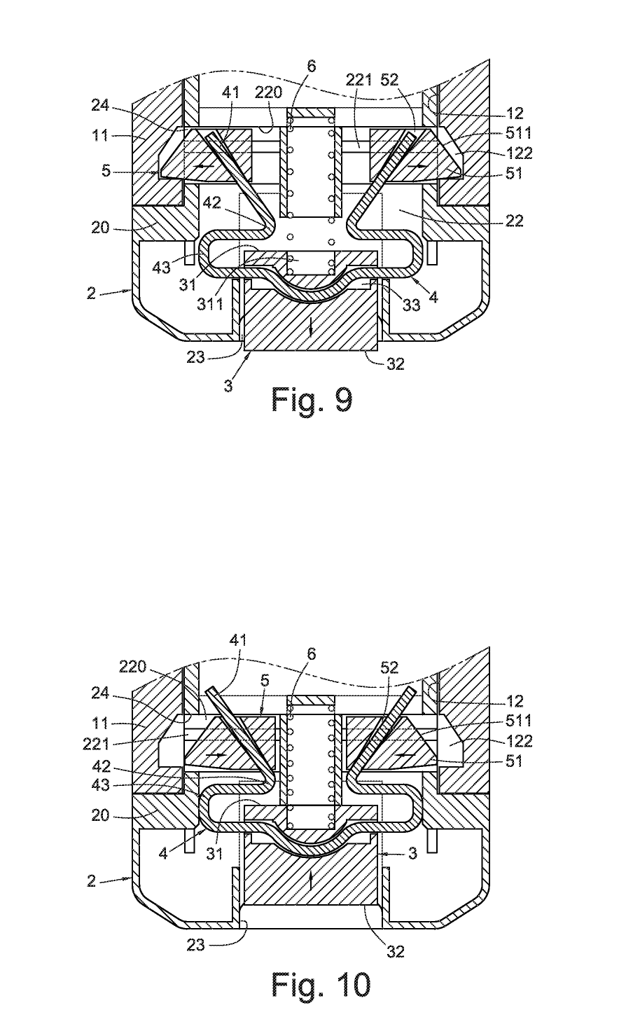

The groove 12 comprises two corresponding open buckling grooves 122 formed on two inner sidewalls, and the buckling grooves 122 are connected to the buckling track 121. The latching elements 5 are respectively positioned in the chamber 22 of the base 20 positioned on the two sides of the path 30 close to the inner portion 31. The chamber 22 of the base 20 restricts the latching element 5 from moving along a direction perpendicular to the path 30 thus moving the latching element 5 towards the outer portion of the two sides of the base 20 (as shown in FIGS. 9 and 10). In an embodiment, a sliding groove 220 is formed vertically along the path 30 on the inner sidewall of the chamber 22 of the base 20 (referring to FIGS. 5 and 6). A through opening 24 is formed connecting the sliding groove 220 with the outer space on the two sides of the base 20. When the base 20 is received into the groove 12, the through opening 24 is positioned on a side corresponding to the buckling groove 122. The latching element 5 is positioned to slide in the sliding groove 220 and is restricted by the inner sidewall of the chamber 22 of the base 20. The latching element 5 has a buckling portion 51 extending vertically along the path 30 (referring to FIG. 4). The latching element 5 is positioned towards the through opening 24. The buckling portion 51 can move along the sliding track 220 with the latching element 5 and protrude out of the base 20 through the through opening 24, and the buckling portion 51 is positioned into the buckling groove 122 to hold to the inner sidewall of the groove 12. The buckling portion 51 has a slope 511 facing upwards and a back facing the button 3. In another embodiment, the latching element 5 has a guiding groove 53 formed vertically along the path 30, and a track 221 is positioned vertically along the two sides of the path 30 on the inner sidewall of the chamber 22 of the base 20. The latching element 5 is slidingly positioned on the track 221 in the guiding groove 53, and restricts the latching element 5 from moving a direction perpendicular to the path 30.

The pushing elements 41 are respectively positioned between the inner portion 31 and the latching element 5 (referring to FIGS. 3 and 4). In the embodiment, the pushing elements 41 respectively positioned on the inner portion 31 extend respectively along the path 30, and the pushing elements 41 decline toward the two sides of the base 20 to form a V shape. An inward bent portion 42 and an outward bent portion 43 are formed on the bottom of the pushing element 41 to accumulate elasticity, and the outward bent portion 43 is positioned on the inner portion 31; the inward bent portion 42 and the outward bent portion 43 are positioned to increase the elasticity of the pushing element 41. The pushing element 41 can be integrally formed as one-piece forming a dual end of a resilient element 4. The resilient element 4 can be bent in a V shape; the button 3 can have a space 33 on a side thereof. The resilient element 4 is received in the space 33. The outward bent portion 43 can reduce the gap between the pushing element 41 and the bottom, and the inward bent portion 42 helps to make the pushing element 41 decline in a V shape and extend to the inner portion 31.

More specifically, the latching element 5 can have a diagonal through hole 52 connecting the top and the bottom of the latching element 5. The latching elements 5 can respectively movably conceal onto the pushing element 41 through the through hole 52. Thus, the pushing element 41 can move back and forth along the button 3 (as shown in FIGS. 9 and 10) and accordingly drive the latching element 5 to move back and forth. Therefore, the latching element 5 can buckle on to the buckling groove 122 to the groove 12 outside the two sides of the base 20 or release from the groove 12 for positioning or releasing the base 20 in the groove 12.

The above elements in the embodiment of the present invention, when base 20 is received into the groove 12 without touching the button 3 (as shown in FIGS. 7 and 9), the buckling track 121 restricts the base 20 in the groove 12 (referring to FIG. 8), the spring 6 drives the button 3 to move downwards to further draw the pushing element 41 to move along the button 3, as well as drives the buckling portion 51 of the latching element 5 to move to the buckling groove 122 through the through opening 24, and thereby make the latching element 5 buckle to the inner sidewall of the two sides of the groove 12 to position the base 20 in the groove 12, and accordingly, the battery pack 2 supplies power through the handle 11 to the motor 13 of the electrical tool 1 (as shown in FIG. 2).

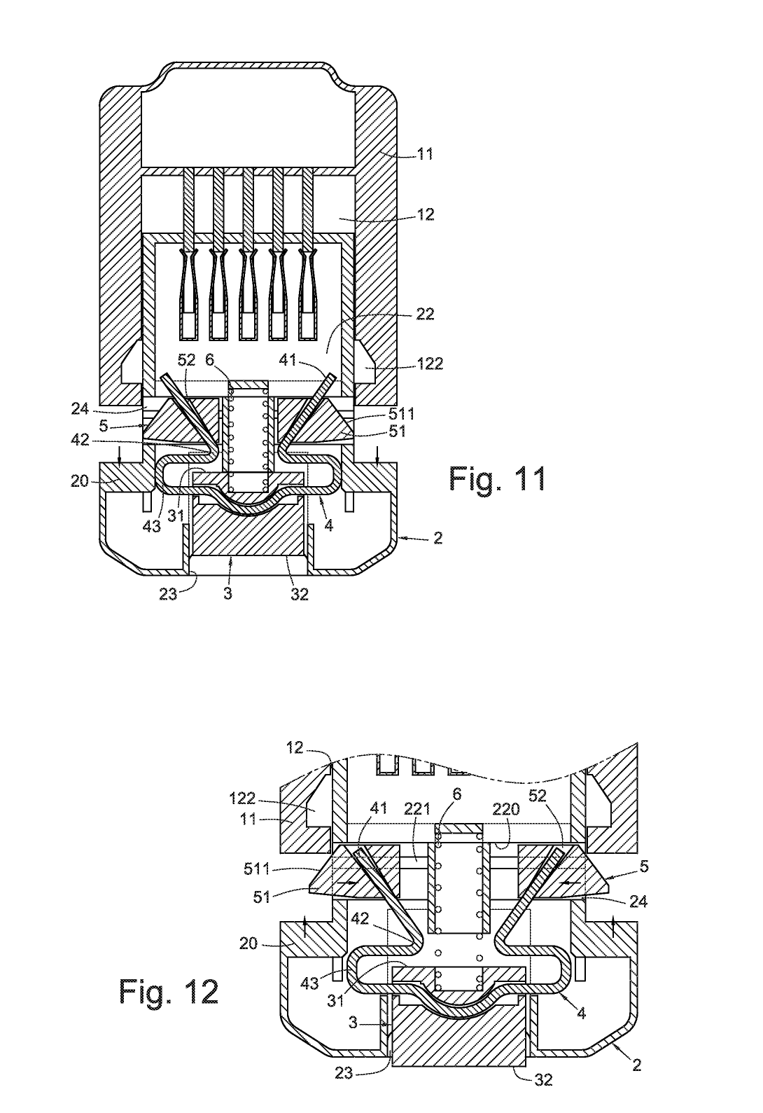

To change the battery pack 2, the button 3 is pressed (referring to FIG. 10) to move the button 3 up and make the pushing element 41 move upwards. The buckling portion 51 of the latching element 5 accordingly move to the sliding groove 220 of the chamber 22 from the buckling groove 122 through the through opening 24, and releasing the latching element 5 from the inner sidewall of the two sides of the groove 12 to release the base 20. Furthermore, the base 20 comes out of the groove 12 from the top to the bottom (as shown in FIG. 11).

To reload the battery pack 2, the button 3 is pressed upwards (as shown in FIG. 10) to inlay the base 20, from the bottom to the top, into the groove 12, then release the button 3 to make the latching element 5 buckle to the inner sidewall on the two sides of the groove 12 to position the base 20 in the groove 12; or without pressing the button 3, inlay the base 20, from the bottom to the top, into the buckling groove 122 (FIGS. 1 and 8) to draw the latching element 5 into sliding groove 220 of the chamber 22, and to elastically bend the inward bent portion 42 and the outward bent portion 43 to smoothly pass the latching element 5 through the inlet of the buckling track 121. When the latching element 5 moves to the position corresponding to the buckling groove 122, inward bent portion 42 and the outward bent portion 43 resiliently restore the position, and accordingly the pushing element 41 is driven to further move the latching element 5 into the buckling groove 122 to buckle to the inner sidewall of the groove 12 and to position the base 20 therein.

Accordingly, the button 3 and the latching element 5 respectively carry the elasticity of the spring and the V shape element, as well as carry the elasticity along a single direction, and make the button 3 drive the pushing element 41 move back and forth along the path 30, and to make the pushing element 41 drive the latching element 5 move back and forth vertically along the path 30, and use the two latching elements 5 to restrict the two corresponding positions of the two sides of the base 20 to position the battery pack 2. Therefore, the spring and the other resilient element in the present invention substantially increase the lifespan thereof, and increase the smoothness of pressing the button 3 to release the battery pack 2 from the latching element 5, and as well as increase the stability of the buckling state of the latching element 5 to the battery pack 2 to effectively prevent the battery pack 2 from coming loose.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A latching mechanism for a battery pack of an electrical tool, wherein the battery pack comprises a base received in a groove formed in a distal end of a handle of an electrical tool; the latching mechanism comprising:
a button, slidingly and elastically positioned in the base, comprising an inner portion and an outer portion respectively formed on two sides of the button; wherein the button is touched on the outer portion to move the button back and forth in the base along a path;
two latching elements, respectively slidingly positioned along the path in the base proximate to the inner portion; wherein the base comprises an inner sidewall to restrict the latching elements to move vertically along the path to allow the latching elements protrude out of two sides of the base; and
two pushing elements, respectively positioned between the inner portion and the latching elements, wherein the pushing element can move back and forth along the button to drive the latching elements to move back and forth to enable the latching elements to buckle to the groove formed on outer portion of the two sides of the base, or to release from the groove.

2. The latching mechanism for a battery pack of an electrical tool according to claim 1, wherein the groove comprises two open buckling grooves formed on the inner sidewall of two side thereof, and protruded tracks are respectively formed on the two sides of the base for being received into the buckling groove.

3. The latching mechanism for a battery pack of an electrical tool according to claim 1, wherein the groove comprises two open buckling grooves formed on an inner sidewall of two sides thereof, and the latching elements protrude out of the two sides of the base to inlay into the groove to buckle to the inner sidewall of the groove.

4. The latching mechanism for a battery pack of an electrical tool according to claim 1, wherein the base comprises an opening formed on a bottom portion thereof and exposed out of the groove, the path is formed between a top and a bottom of the base to allow the button slide up and down in the base; the inner portion is formed on a top of the button and the outer portion is formed on a bottom of the base and exposed out of the base through the opening.

5. The latching mechanism for a battery pack of an electrical tool according to claim 1, wherein a spring is positioned between the button and the base, and the button carries elasticity through the spring.

6. The latching mechanism for a battery pack of an electrical tool according to claim 5, wherein the top of the button comprises a positioning groove and the spring is positioned between the positioning groove and the inner sidewall of the base to drive the button to move downwards.

7. The latching mechanism for a battery pack of an electrical tool according to claim 1, wherein on the inner sidewall of the base on two sides of the path respectively comprises a sliding groove formed vertical along the path, and an opening connecting to the sliding groove respectively formed on two sides of the base; the latching element is positioned in the sliding groove and restricted by the inner sidewall of the base to slide.

8. The latching mechanism for a battery pack of an electrical tool according to claim 1, wherein the latching element comprises a guiding groove formed along a vertical path, and on the inner sidewall of the base on two sides of the vertical path, a guiding track is formed along the vertical path; and the latching element is positioned on the guiding track through the guiding groove.

9. The latching mechanism for a battery pack of an electrical tool according to claim 1, wherein a diagonal through hole is formed on the latching element to conceal onto the pushing element.

10. The latching mechanism for a battery pack of an electrical tool according to claim 1, wherein the latching element comprises a buckling portion extending vertically along the path and the buckling portion can move along with the latching element out of the base.

11. The latching mechanism for a battery pack of an electrical tool according to claim 10, wherein the buckling portion comprises a slope with its back facing the button.

12. The latching mechanism for a battery pack of an electrical tool according to claim 1, wherein the pushing elements are positioned on the inner portion and extending respectively along the path and declining towards two sides of the base.

13. The latching mechanism for a battery pack of an electrical tool according to claim 1, wherein the pushing elements are positioned in a V shape.

14. The latching mechanism for a battery pack of an electrical tool according to claim 1, wherein the pushing elements comprise more than one bent portion accumulating elasticity.

15. The latching mechanism for a battery pack of an electrical tool according to claim 1, wherein the pushing elements are integrally formed as a one-piece element forming two distal ends of a resilient element.

16. The latching mechanism for a battery pack of an electrical tool according to claim 15, wherein the resilient element is bent in a V shape.

17. The latching mechanism for a battery pack of an electrical tool according to claim 15, wherein the button comprises a space to receive the resilient element.
